(19) United States
(12) Patent Application Publication
(10) Pub. No.: US 2010/0134872 A1
(43) Pub. Date: Jun. 3, 2010

(54) SWITCHABLE GRATING BASED ON ELECTROPHORETIC PARTICLE SYSTEM

(75) Inventors: Mark Thomas Johnson, Veldhoven (NL); Sander Jurgen Roosendaal, Brno (CZ); Patrick John Bsesjou, Eindhoven (NL); Dirk Kornelis Gerhardus De Boer, Den Bosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/515,292

(22) PCT Filed: Nov. 6, 2007
(86) PCT No.: PCT/IB2007/054504

§ 371 Date: May 18, 2009

Related U.S. Application Data
(60) Provisional application No. 60/866,695, filed on Nov. 21, 2006.

(51) Int. Cl. G02F 1/167

(52) U.S. Cl. 359/296

(57) ABSTRACT

A switchable optical component (10) includes a substrate (18) forming a cavity (14). The substrate (18) is configured with a structured surface (24, 26) adjacent to the cavity, and the substrate has a first index of refraction. A fluid (16) contacts the structured surface. Particles (12) are selectively dispersible in the fluid such that a first concentration of particles in the fluid enables the structured surface to provide an optical effect, and a second concentration of particles in the fluid disables the optical effect.

This disclosure relates to switchable optical devices and more particularly to switchable grating devices employing electrophoretic particles to selectively alter the index of refraction.

Electrophoretic systems have found extensive application as a switchable optical layer for display devices. Examples of electrophoretic systems include black-white electronic paper display devices made by Philips® and E-Ink® in the Sony® Librié e-reader and in-plane switching electrophoretic displays aimed at signage applications. In all cases, the particles in the electrophoretic systems are used to absorb (part of) the light in an optical shutter configuration—either in a reflective or a transmissive configuration.

In accordance with present principles, a far less exploited optical characteristic of the electrophoretic system is the ability of the electrophoretic particles to operate as switchable diffractive optical components. In most cases, this property is overshadowed by the absorbing, reflecting or scattering properties of the electrophoretic system. However, as well as absorption, the particles are made of a material with a different refractive index than a solvent used to suspend or carry the particles. Hence, it is possible to generate local changes in the effective refractive index of the fluid by locally concentrating the particles.

To illustrate that refractive optics is possible, an experimental system has been created by the present inventors where refractive properties of the particles are exploited to create a switchable optical device, in one example, a switchable grating. In this example, to study the refractive properties, absorption was obviated. Illustratively, magenta particles were selected with an absorption spectrum with a known absorption region so that the absorption region could be avoided. Scattering was avoided by employing a small size for the magenta particles (˜100 nm). Sufficient change in optical path was also provided (e.g., d×Δn, where Δn is the index difference). A thick layer of a concentrated suspension provided potential for large optical path differences.

In one illustrative embodiment, a switchable optical component includes a substrate forming a cavity. The substrate is configured with a structured surface adjacent to the cavity, and the substrate has a first index of refraction. A fluid is contacted with the structured surface. Particles are selectively dispersible in the fluid such that a first concentration of particles in the fluid enables the structured surface to provide an optical effect, and a second concentration of particles in the fluid disables the optical effect.

In another embodiment, a method for operating a switchable optical component includes providing an in-plane electrophoretic device having a substrate forming a cavity where the substrate is configured with a grating profile adjacent to the cavity and the substrate has a first index of refraction, contacting the grating profile with a fluid, and selectively dispersing particles in the fluid such that a first concentration of particles in the fluid enables the grating profile to provide an optical effect and a second concentration of particles disables the optical effect.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

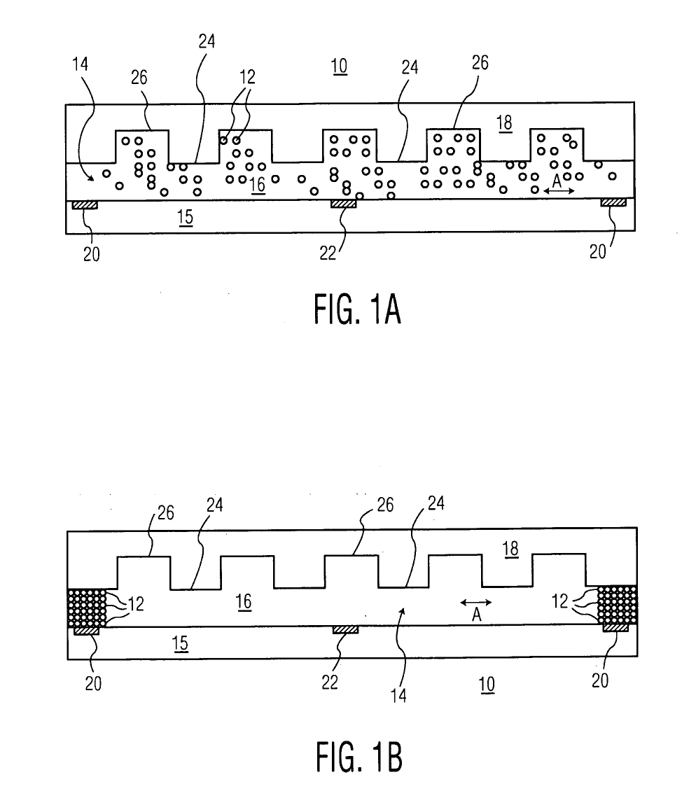

FIG. 1A is a cross-sectional view of a switchable diffractive optical device having an in-plane switching electrophoretic mechanism which disperses particles using electrodes on a same side of a cavity and provides a refractive index difference to permit diffraction in accordance with one embodiment;

FIG. 1B is a cross-sectional view of the switchable diffractive optical device of FIG. 1A showing the particles collected laterally outside the grid profile area in accordance with this embodiment;

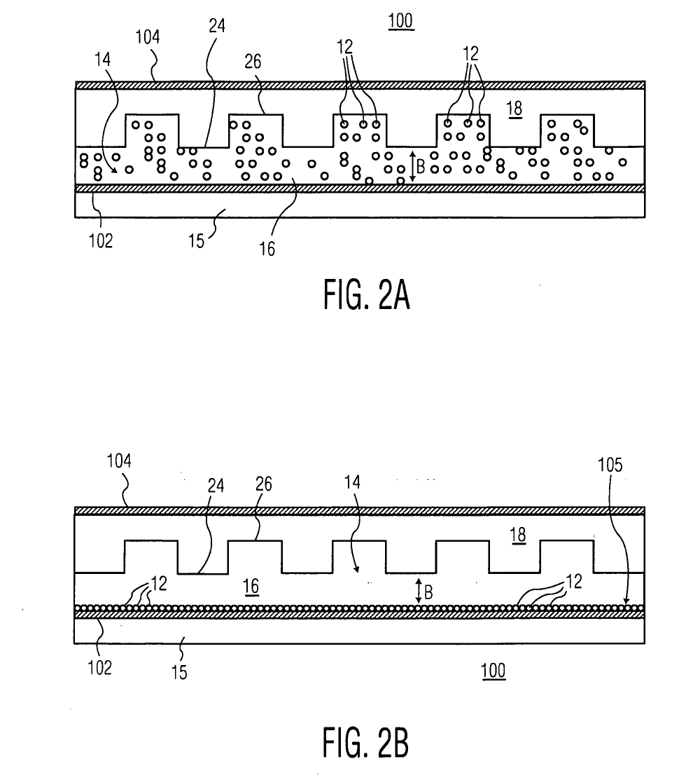

FIG. 2A is a cross-sectional view of another switchable diffractive optical device having an in-plane switching electrophoretic mechanism which disperses particles using electrodes on opposite sides of a cavity and provides a refractive index difference to permit diffraction in accordance with another embodiment;

FIG. 2B is a cross-sectional view of the switchable diffractive optical device of FIG. 2A showing the particles collected in a uniform layer through the grid profile area in accordance with this embodiment;

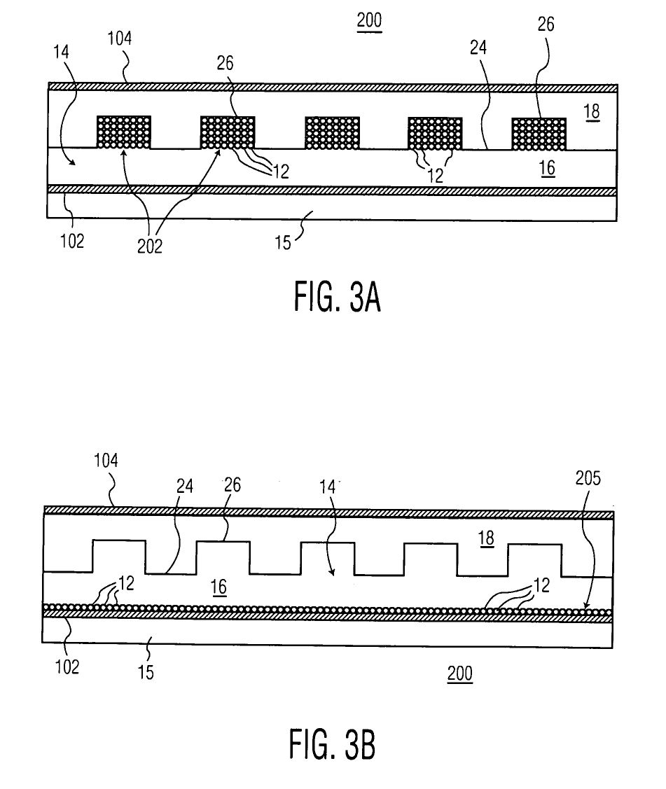

FIG. 3A is a cross-sectional view of another switchable diffractive optical device having an in-plane switching electrophoretic mechanism which disperses particles using electrodes on opposite sides of a cavity to fill spaces in a grid profile to provide a refractive index difference to permit diffraction in accordance with another embodiment;

FIG. 3B is a cross-sectional view of the switchable diffractive optical device of FIG. 3A showing the particles collected in a layer through the grid profile area in accordance with this embodiment;

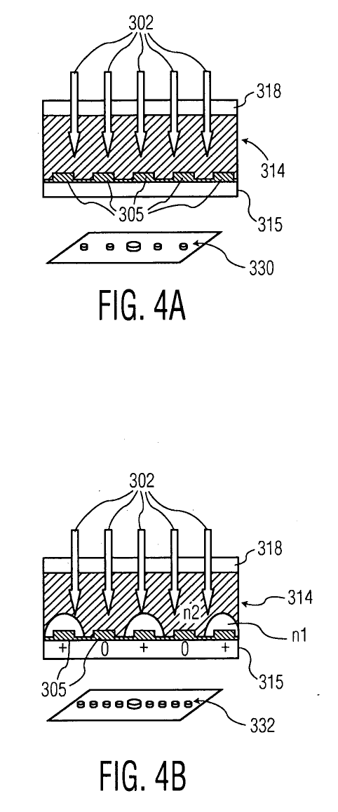

FIG. 4A is a cross-sectional view of a switchable diffractive optical device used in an experiment performed by the inventors showing a diffraction pattern due to electrode spacings;

FIG. 4B is a cross-sectional view of the device of FIG. 4A where alternate electrodes have a non-zero voltage to create particle free areas in a fluid such that a refractive index difference is caused to permit diffraction in accordance with another embodiment; and

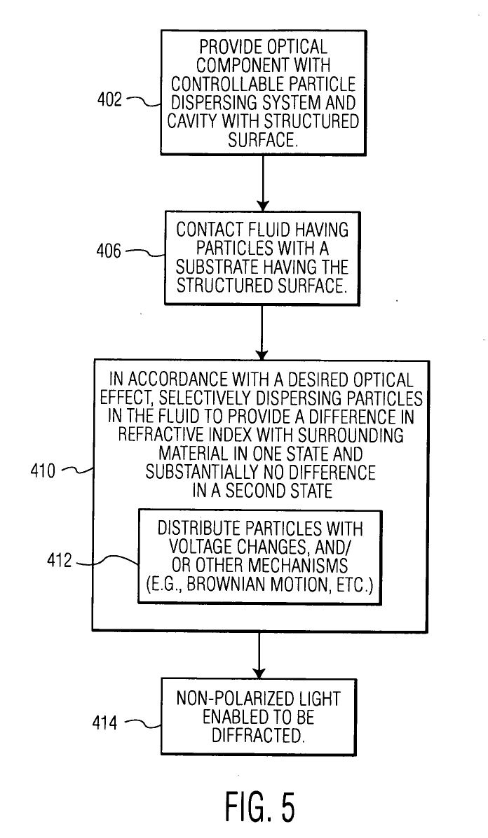

FIG. 5 is a flow diagram showing an illustrative method for operating a switchable optical component in accordance with the present principles.

It should be understood that the present invention will be described in terms of electrophoretic display devices; however, the teachings of the present invention are much broader and are applicable to any components that can employ adjustable indices of refraction to provide an optical effect, such as, a diffraction grating or other switchable index of refraction device. Embodiments described herein are preferably located and processed using lithography and hence are located in accordance with the applicable accuracy of the lithographic process selected. It should be noted that photolithographic processing is preferred but merely illustrative. Other processing techniques may also be employed.

It should also be understood that the illustrative examples of the switchable diffractive gratings may be adapted to include additional electronic components that may employ the light diffracted by such gratings or may assist in selecting the mode of operation of such gratings. These components may be formed integrally with a substrate or mounted on the substrate or provided in or on other components. The diffraction grating may be employed with other devices not integrally formed with the diffraction grating. The elements depicted in the Figures may be implemented in various combinations of hardware and provide functions which may be combined in a single element or multiple elements.

In accordance with particularly useful embodiments, a well-defined switchable optical grating may be provided based upon an electrophoretic particle system and a pre-formed cavity. The grating operation is based upon movement of particles having a different refractive index than a fluid (liquid or gas) in which the particles are suspended. The particles are preferably electrophoretic and are therefore attracted or repulsed depending on a voltage or other motion inducing mechanism. In one configuration, the fluid and the material forming the cavity have the same or substantially the same refractive index (e.g., within about 2%) such that when the particles are removed the device does not work as a grating. By moving the particles into the fluid in the cavity, the fluid and the material adjacent to the cavity have a different refractive index and the device operates as a grating. Some applications for such a switchable grating include optical storage, light beam re-direction, optical in/out-coupling, spectroscopy/lighting (separating white light into its component colors), etc. One advantage of such a switchable grating is that it does not rely upon polarized light (as is the case for the prior art switchable liquid crystal (LC) gratings) and is therefore much more light efficient.

Referring now to the drawings in which like numerals represent the same or similar elements and initially to FIGS. 1A and 1B, a switchable optical grating 10 is shown in accordance with one illustrative embodiment. Grating 10 switches from a well-defined first state (for example, a non-grating state) in FIG. 1B to a well-defined second grating intensity state in FIG. 1A. The grating device 10 is based upon an electrophoretic particle system where particles 12 are present in a pre-formed cavity 14. The grating 10 operates based upon movement of particles 12 in a fluid (liquid or gas) 16 where the particles 14 and the fluid 16 have different refractive indexes. Preferably, the device 10 operates in two well-defined states or configurations for forming a diffraction grating based on lateral particle movement. Embodiments disclosed herein locally change the refractive index by changing the particle concentration in the fluid 16. In practical applications, the concentration of the particles 12 may be varied from 0 weight percent to about 60 weight percent (or more), and this may give a very large refractive index change. It should be understood that depending on the design and application, the refractive index of the fluid with an equilibrium particle concentration may be index matched to surrounding material to provide a first state and a non-equilibrium particle concentration to provide a second state (or vice versa).

A low particle concentration may be achieved by collecting all particles on electrodes 20 or devices, and repelling particles from electrode 22. In this way, the concentration elsewhere in the cavity 14 may be as low as 0. For example, in a first state (FIG. 1B), there are virtually no particles in the fluid 16 in the cavity 14 (e.g., about a 0 weight percent). The fluid 16 and a surrounding material 18 forming the cavity 14 may have the same refractive index such that without particles 12, the device 10 does not operate as a grating. A high particle concentration may be achieved at or close to the collecting electrodes 20.

In a second state (FIG. 1A), by moving the particles 14 or permitting the particles to reach equilibrium in a homogenous manner into the fluid 16 in the cavity 14, the fluid 16 and the particles 12 in the cavity 14 achieve a refractive index that is different from material 18, and the device 10 operates as a grating.

Alternately, it should be understood that the equilibrium state shown in FIG. 1A may function as a non-grating state if the resulting particle concentration in the fluid 16 results in a substantially same refractive index between the fluid with particles and the surrounding material 18. Likewise, in this alternate embodiment, the configuration in FIG. 1B could act as a grating since the fluid 16 and the surrounding material 18 could have different indexes of refraction. Other embodiments and configurations, such as cavity shapes, sizes and types of particles and different fluid types are also contemplated.

Distribution of particles 12 within fluid 16 may be performed in a plurality of ways. In one embodiment, electrodes 20 and 22 are formed on a substrate 15 (along with circuitry (not shown)) for activating and controlling the electrodes 20, 22. Electrodes 20 may be energized to attract or repel particles 12 to remove the particles 12 from the grating area (FIG. 1B). During operation, a grating electrode 22 is energized to draw the particles into the grating area. The electrodes 20 and 22 may then be alternately energized to disperse the particles in the fluid 16. Alternately, the particles may be left to disburse by natural means, e.g., Brownian motion, or other forced means, e.g., by vibration, temperature changes or other mechanical force.

Material 18 is preferably formed into a structured surface such as, e.g., a grating profile having protrusions 24 and troughs 26. Structured surfaces may also include prisms or other optical elements as well. Protrusions 24 and troughs 26 are configured to have a predetermined pitch associated with the wavelength of light to be diffracted. In one embodiment, the refractive index of the fluid 16 may be substantially the same as that of a substrate or material 18 in which the troughs 26 are formed. The particles 12 may then be introduced into the fluid 16 to modify the refractive index. In the embodiment of FIGS. IA and 1B, the particles 12 travel with a lateral motion induced by changing the voltage on one or more of a plurality of laterally separated electrodes 20 and 22. The lateral motion is generally characterized in the direction of arrow “A”. Of course, the particles 12 also move in a direction perpendicular to arrow “A”, but for ease of reference, the particles 12 will be described for this embodiment to be moved laterally or along the major axis of the substrate 15.

The in-plane electric field moves the particles into the cavity 14. The particles 12 may be distributed throughout the cavity under the influence of Brownian motion, or alternatively by applying small AC signals to the electrodes to mix up the particles. In this embodiment, re-distributing the arrangement of particles having a first refractive index in a liquid of a different refractive index employs particle motion in the lateral direction along the major axis of the device 10. The cavity 14 has the form of a grating in that the cavity 14 includes protrusions 24 and troughs 26 (e.g., with a well defined lateral spacing). The regions with different heights due to the protrusions 24 and troughs 26 result in different optical path lengths through the device 10 (and hence the degree of diffraction) while their lateral spacing defines the angle at which diffraction beams will emerge from the grating. Optionally, one device according to the present principles may include a plurality of such cavities 14 laterally disposed next to each other, e.g., in the form of an array. Alternately, a plurality of cavities may be stacked on top of one another. These cavities/devices may be individually or collectively switchable.

A switchable grating in accordance with the present principles may be employed for optical storage, diffraction, light beam re-direction, optical in/out-coupling, spectroscopy/lighting (separating white light into its component colors), or any other application. The switchable grating 10 advantageously does not rely upon polarized light to provide diffraction and is therefore much more light efficient.

Referring to FIGS. 2A and 2B, a grating 100 with perpendicular particle movement is illustratively shown. In this embodiment, a switchable grating 100 is formed by re-distributing the arrangement of particles 12 with a first refractive index in a fluid 16 of a different refractive index in a pre-formed cavity 14. The particle motion is generally in the perpendicular direction to a major axis of substrate 15. The perpendicular motion is generally characterized in the direction of arrow “B”. Of course, the particles 12 also move in a direction perpendicular to arrow “B”, but for ease of reference, the particles 12 will be described for this embodiment to be moved perpendicularly.

The cavity 14 has the form of a grating and includes protrusions 24 and troughs 26 with a well defined lateral spacing. The regions with different height on substrate 18 result in different optical path lengths through the device (and hence the degree of diffraction) while their lateral spacing defines the angle at which diffraction beams will emerge from the grating. Optionally, one device according to the present principles may include a plurality of such cavities laterally disposed next to each other, e.g., in the form of an array. Alternately, a plurality of cavities may be stacked one on top of the other. The cavities may be individually or collectively switchable.

In one embodiment, the refractive index of the fluid 16 is substantially the same as that of the substrate 18 in which the cavity 14 is formed in FIG. 2B. In this case, the distributed particles 12 are disposed along a bottom surface of cavity 14 resulting in a low concentration of particles in the fluid. In this example, an optical device without a diffraction grating is thereby realized as shown in FIG. 2B. To realize an operating diffraction grating, the particles 12 are distributed in the fluid 16, thereby modifying the refractive index and creating a grating as shown in FIG. 2A.

As shown in FIG. 2B, the particles 12 are located on or near a bottom electrode 102 to form a uniform layer 105, which is preferably formed on a flat surface of substrate 15. In the example shown, the particles form layer 105 of uniform thickness on the flat (bottom) surface of the cavity 14, whereby the fluid 16 remains in a grating form with a different refractive index from that of the substrate 18. This may be accomplished by adjusting or setting a voltage of the bottom electrode 102 or a top electrode 104 so that the particles are driven to the bottom electrode 102. When it is desirable to switch the device to a diffraction grating, particle motion is induced by changing the voltage on one or both of the vertically separated electrodes 102 and/or 104. Voltages may be switched or alternated to provide a randomized distribution of particles 12 in the cavity 14 and cause diffraction of incident light.

Alternately, as described above, it should be understood that a grating may be realized in the state of FIG. 2B if the low particle concentration fluid 16 is not matched with substrate 18, and a high particle concentration fluid 16 with particles 12 (FIG. 2A) is matched with substrate 18.

Referring to FIGS. 3A and 3B, a diffraction grating 200 includes a cavity 14 having fluid 16 and particles 12. In one embodiment, a diffraction grating is realized in FIG. 3B, when particles 12 form a layer 205 of uniform thickness on the flat (bottom) surface of the cavity 14. The particles 12 are controlled by applying a voltage to bottom electrode 102 and/or top electrode 104. To change or remove the grating, the particles 12 are distributed in the fluid 16 to modify the refractive index distribution and change the strength of the grating. In the example of FIG. 3A, the particles 12 are moved to a structured upper surface, formed in substrate 18. The motion of the particles 12 is induced by changing the voltage on one or both of electrodes 102 and 104 of the vertically separated electrodes. In the example shown in FIG. 3A, the particles 12 form a layer 202 on the structured (top) surface of the cavity 14. If, for example, the average refractive index of the compacted particles 12 in the fluid 16 is similar to that of the substrate 18, and the particles 12 fill in the spaces between the grating structures (e.g., protrusions 24 and troughs 26) and effectively planarize the surface, the operations of the grating will be reduced or removed.

Alternately, it should be understood that a grating may be realized in the state of FIG. 3A if at least the particles 12 (and perhaps fluid 16) do not index match with substrate 18.

A non-grating configuration may be realized if the fluid 16 in FIG. 3B is matched with substrate 18.

In the present embodiments, different variations with matched or non-matched refractive index fluid and fluid with particle concentrations are possible. For example, the refractive indexes of the fluid, substrate and particles may be adjusted to achieve a desired optical effect. In some embodiments, systems may be considered where the refractive index of the particles exceeds that of the fluid. For example, the use of small, non-scattering titanium oxide particles with a refractive index of around 2.70 (Retile) or 2.55 (Anastasia) may be employed in an oil, such as, e.g., dodecan with a refractive index of 1.42. Alternatively, a system where the refractive index of the particles is less than that of the fluid may be employed. For example, the use of small hollow, air filled particles with a refractive index of around 1.1-1.2 may be employed in an oil such as, e.g., dodccan with a refractive index of 1.42, biphenyl (n=1.59), phenyl naphthalene (n=1.67), bromobenzene (n=1.56), choloronaphthalene (n=1.63), bromonaphthalene (n=1.64), methoxynaphthalene (n=1.69), polybromoaromatics, polybromoalkanes, etc. Furthermore, it is not necessary to use oil-based liquid-particle systems. Water, water-like fluids or other fluids (combined with the appropriate particles) are also contemplated. As mentioned, the particles may be transported by a plurality of different mechanisms.

While voltages may be employed, other transport mechanisms may also be employed in addition to or instead of electrical mechanisms. For example, the transport mechanism for the particles may include dielectrophoresis, electohydrodynamics, electro-osmosis, etc. Dielectrophoresis occurs when particles move to or away from regions with high field strength, based on an induced dipole. The electrode design may be adapted to provide desired motion of particles, and the frequency of the applied field may be employed to move the particles around. Electrohydrodynamics is a general term covering all kinds of particle movement in fluids by electric fields, and electro-osmosis is the movement of a polar liquid through a membrane by an electric field.

It should also be understood that the monochromatic or other light to be diffracted may pass from top to bottom or bottom to top (in FIGS. 1-3) through the device. Substrates 15 and/or 18 and accompanying electrodes need to provide transparency and an appropriate index of refraction to promote effective operation. The present principles were demonstrated by the inventors in an experiment schematically depicted in FIGS. 4A and 4B. The experiment demonstrated that an active electrophoretic optical component could be provided using non-polarized optics. Referring to FIG. 4A, a red laser was employed to generate light 302 at 690 nm. The light 302 passed through a substrate 318 and a liquid filled cavity 314 which was filled with dodecane and magenta particles (˜100 nm in size). The magenta particles in the fluid included a high refractive index (n2) that was larger than the refractive index (n1) of the fluid alone without the particles. Inter-digitated electrodes 305 were evenly dispersed on a second substrate 315. A diffraction pattern 330 was realized as a result of the pattern of electrodes 305.

Referring to FTG. 4B, when an alternating zero voltage-non-zero voltage pattern was applied to the electrodes 305, particles were removed from the volume around the non-zero positive voltage electrodes (designated with a “+” sign) causing a difference in refractive index. Additional diffraction spots were visible in the diffraction pattern 332, thus demonstrating that particle free areas 322 caused the extra diffraction spots.

The experiment demonstrated that while fast switching of the grating is achievable (e.g., on the order 1-10 seconds), changes of the intensity of the extra diffraction spots were produced as maxima and minima of interference (as retardation increased through integral numbers of wavelengths).

Referring to FIG. 5, a method for operating a switchable optical component is illustratively shown. In block 402, an optical component with an in-plane electrophoretic device (or other particle dispersing system) is provided. In one embodiment, the device includes a substrate, which forms a cavity. The substrate is configured with a grating profile or structured surface adjacent to the cavity, and the substrate has a first index of refraction. In block 406, the grating profile is contacted with a fluid having particles therein. This may be as a result of manufacture/assembly of the device or the fluid level may be controlled during operations of the device. In any case, the fluid contacts the grating profile of structure surface.

In block 410, particles are selectively dispersed in the fluid. The fluid and the particles have at least two states (additional states are also possible). One state includes an index of refraction that is the same or substantially the same as the first index of refraction of the substrate, and another state includes an index of refraction for the fluid and the particles that is different from the first index of refraction. When the particles are in one of the states, the grating profile diffracts incident light and in the other of the states, no diffraction is caused by the grating profile. The different indexes of refraction may be higher or lower as the case may be.

When the fluid and particles are in a first configuration (a first concentration), the grating profile diffracts or causes an optical effect on the incident light, and in a second configuration (a second concentration), the light is not diffracted or the optical effect is not provided. The particles may include electrophoretic particles. The particles may be selectively dispersed due to voltage changes in proximity of the fluid or by other means. In block 412, the voltage changes may be implemented using electrodes disposed adjacent to the cavity wherein the particles are dispersed in the fluid by altering the voltages on the electrodes and/or permitting disbursement using other mechanisms (e.g., Brownian motion). The electrodes may be disposed on a same side of the cavity or on opposite sides of the cavity. In one configuration, the particles may be dispersed to form a uniform layer of particles in the cavity opposite the grating profile or to collect the particles laterally outside of an area of the grating profile. The particles may also be collected in portions of the grating profile. Advantageously, in block 414, the incident light does not need to be polarized to be diffracted. The non-polarized light can be diffracted using the grating profile.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) no specific sequence of acts is intended to be required unless specifically indicated.

Having described preferred embodiments for a switchable grating based on electrophoretic particle system (which are intended to be illustrative and not limiting), it is noted that modifications and variations can be made by persons skilled in the art in light of the above teachings. It is therefore to be understood that changes may be made in the particular embodiments of the disclosure disclosed which are within the scope and spirit of the embodiments disclosed herein as outlined by the appended claims. Having thus described the details and particularity required by the patent laws, what is claimed and desired protected by Letters Patent is set forth in the appended claims.

1. A switchable optical component, comprising:
a substrate (18) forming a cavity (14), the substrate being configured with a structured surface (24, 26) adjacent to the cavity and the substrate having a first index of refraction;
a fluid (16) in contact with the structured surface; and
particles (12) selectively dispersible in the fluid such that a first concentration of particles in the fluid enables the structured surface to provide an optical effect and a second concentration of particles in the fluid disables the optical effect.

2. The component as recited in claim 1, wherein the particles (12) include electrophoretic particles and the particles are dispersible based on voltage changes in proximity of the fluid.

3. The component as recited in claim 2, further comprising a plurality of electrodes (20, 22) disposed adjacent to the cavity wherein the particles are dispersed in the fluid by altering the voltages on the electrodes.

4. The component as recited in claim 3, wherein the electrodes (20, 22) are disposed on a same side of the cavity.

5. The component as recited in claim 3, wherein the electrodes (102, 104) are disposed on opposite sides of the cavity.

6. The component as recited in claim 1, where, in one of the first concentration and the second concentration, a uniform layer (105) of particles are formed in the cavity opposite the structured surface.

7. The component as recited in claim 1, where, in one of the first concentration and the second concentration, the particles (12) are laterally collected outside of an area of the structured surface.

8. The component as recited in claim 1, where, in one of the first concentration and the second concentrations, the particles (12) are collected in portions of the structured surface.

9. The component as recited in claim 1, wherein the structured surface includes a grating profile (24, 26).

10. The component as recited in claim 9, wherein the incident light is non-polarized and the grating profile provides diffraction of the incident light.

11. A switchable diffraction grating, comprising:
a substrate (18) forming a cavity (14), the substrate being configured with a diffraction grating profile (24, 26) adjacent to the cavity and the substrate having a first index of refraction;
a fluid (16) in contact with the grating profile;
electrophoretic particles (12) selectively dispersible in the fluid such that a first concentration of particles in the fluid enables the grating profile to provide an optical effect and a second concentration of particles in the fluid disables the optical effect; and
a plurality of electrodes (20, 22, or 102, 104) disposed adjacent to the cavity wherein the particles are dispersed in the fluid by altering voltages on the electrodes.

12. The grating as recited in claim 11, wherein the electrodes (20, 22) are disposed on a same side of the cavity.

13. The grating as recited in claim 11, wherein the electrodes (102, 104) arc disposed on opposite sides of the cavity.

14. The grating as recited in claim 11, wherein, in one of the first and second concentrations of particles, the particles form a uniform layer (105) in the cavity opposite the grating profile.

15. The grating as recited in claim 11, wherein, in one of the first and second concentrations of particles, the particles (12) are laterally collected outside of an area of the grating profile.

16. The grating as recited in claim 11, wherein, in one of the first and second concentrations of particles, the particles (12) are collected in portions of the grating profile.

17. The grating as recited in claim 11, wherein the grating profile is included in an array of gratings.

18. The grating as recited in claim 11, wherein the grating profile is included in a stack of gratings.

19. The grating as recited in claim 11, wherein incident light is non-polarized and the grating profile provides diffraction of the incident light.

20. A method for operating a switchable optical component, comprising:
providing (402) an in-plane electrophoretic device having a substrate forming a cavity where the substrate is configured with a grating profile adjacent to the cavity and the substrate has a first index of refraction;
contacting (406) the grating profile with a fluid; and
selectively dispersing particles (410) in the fluid such that a first concentration of particles in the fluid enables the grating profile to provide an optical effect and a second concentration of particles disables the optical effect.

21. The method as recited in claim 20, wherein the particles include electrophoretic particles and selectively dispersing the particles (410) includes selectively dispersing the particles (412) based on voltage changes in proximity of the fluid.

22. The method as recited in claim 21, wherein the voltage changes are implemented using electrodes disposed adjacent to the cavity wherein the particles are dispersed in the fluid by altering the voltages on the electrodes.

23. The method as recited in claim 22, wherein the electrodes are disposed on a same side of the cavity.

24. The method as recited in claim 22, wherein the electrodes are disposed on opposite sides of the cavity.

25. The method as recited in claim 20, wherein selectively dispersing particles (410) includes forming a uniform layer (105) of particles in the cavity opposite the grating profile.

26. The method as recited in claim 20, wherein selectively dispersing particles (410) includes collecting the particles laterally outside of an area of the grating profile.

27. The method as recited in claim 20, wherein selectively dispersing particles (410) includes collecting the particles in portions of the grating profile.

28. The method as recited in claim 20, wherein incident light is non-polarized and the method includes diffracting the non-polarized incident light using the grating profile.
